(19) United States
(12) Patent Application Publication
(10) Pub. No.: US 2025/0335958 A1
(43) Pub. Date: Oct. 30, 2025

(54) AI-BASED MARKETPLACE PLATFORM FOR DISTRIBUTING AI MODELS AND DOORBELL SECURITY SYSTEMS

(71) Applicant: Khurram Hussain, Irvine, CA (US)

(72) Inventor: Khurram Hussain, Irvine, CA (US)

(21) Appl. No.: 19/192,930

(22) Filed: Apr. 29, 2025

Related U.S. Application Data
(60) Provisional application No. 63/640,397, filed on Apr. 30, 2024.

(51) Int. Cl. G06Q 30/0601; G06F 8/65; H04N 7/18

(52) U.S. Cl. CPC G06Q 30/0603; G06F 8/65; G06Q 30/0641; H04N 7/186

(57) ABSTRACT

A system and method are disclosed for distributing, deploying, and managing artificial intelligence (AI) models on edge devices such as smart doorbells, security cameras, and AI-enabled IoT hubs. The invention provides a centralized AI model marketplace where developers can upload, validate, and list models for various detection tasks, including people, package, pet, and anomaly detection. Users can browse and install these models via a mobile or web application. Models are delivered over-the-air to compatible edge devices, where they are executed locally using an embedded inference engine. The system supports secure model transmission, user authentication, and compliance with privacy regulations. Real-time notifications of detected events are sent to the user's device, and users can review event history, manage subscriptions, and provide model feedback. The invention facilitates a seamless workflow for developers and end-users, enabling dynamic AI capability on smart home devices while preserving user data privacy and minimizing cloud dependency.

### CROSS REFERENCE TO RELATED APPLICATION

This application claims priority from and the benefit of U.S. Provisional Patent Application No. 63/640,397, filed on Apr. 30, 2024, which is hereby incorporated by reference for all purposes as if fully set forth herein.

### FIELD OF THE INVENTION

The present invention relates generally to artificial intelligence (AI) and machine learning marketplaces and, more particularly, to systems and methods that facilitate the creation, distribution, and deployment of AI models, especially computer vision models on custom hardware such as doorbells, security devices, surveillance equipment, or other integrated IoT hardware.

### BACKGROUND

Home security systems have traditionally relied on hardware doorbells and surveillance cameras that stream data to either local storage or cloud-based services for simple motion detection and recording. As machine learning and computer vision have advanced, demand has grown for more sophisticated detection capabilities such as distinguishing between humans and animals, recognizing faces, detecting packages, or identifying anomalous events.

Developers of AI models (including deep learning and other machine learning approaches) often lack a centralized marketplace to showcase and distribute their computer vision models to end users who need advanced security and surveillance features. Conventional approaches require end users to manually install complex software, ensure hardware compatibility, and manage updates. These operations require technical skills as well which most users do not have. Moreover, developers struggle to monetize their solutions or reach a broad customer base. Users seeking specialized computer vision or AI solutions for their hardware devices (such as doorbells) must navigate various third-party sources and frequently do not have a streamlined way to incorporate newly developed models into their systems. At present, no doorbell hardware allows for third-party integration of AI models. Typically, users can access AI models through cloud-based services but cannot deploy them directly on physical devices like doorbells.

Accordingly, a need exists for a unified platform, a marketplace, where AI developers can upload, distribute, and monetize their computer vision and machine learning models and where end users can easily browse, purchase, and integrate those models into custom doorbell hardware or cloud-based solutions. Additionally, there is a need to ensure secure model distribution, provide robust privacy protection, manage updates, and facilitate consistent performance across a wide variety of hardware configurations.

The above information disclosed in this background section is only for enhancement of understanding of the background of the inventive concept, and, therefore, it may contain information that does not form the prior art

### SUMMARY

The present invention relates to a system and method for distributing, deploying, and managing artificial intelligence (AI) models for edge devices such as smart doorbells, security cameras, and AI-enabled IoT hubs. The invention introduces an AI model marketplace platform that allows developers to upload and list AI models categorized by function (e.g., people detection, package detection, anomaly detection) for use on compatible hardware devices. These models are validated for security and compatibility and are made available to end-users who can browse, purchase, or install them through a user-friendly interface via mobile or web applications.

The system comprises a centralized marketplace server responsible for model storage, developer and user management, payment processing, licensing, and automatic validation of uploaded AI models. Users interact with the system via user devices (e.g., smartphones or computers) to discover and install models on their registered hardware. The hardware device, which may include a smart doorbell or similar AI-capable IoT device, includes a camera, an inference engine, and a device controller that orchestrates model downloads and deployment over-the-air (OTA). Once deployed, the AI model performs on-device inference on real-time video streams and generates event-based alerts, such as motion detection, package drop-offs, or intrusions, which are then transmitted to the user's mobile device.

The invention supports developer workflows for model listing, testing, publishing, updating, and monetization, while providing users with personalized, secure, and privacy-preserving AI functionalities. Developers also have access to model testing capabilities. They can evaluate their AI models using the doorbell or a dedicated hardware platform before releasing them to users. The OTA delivery mechanism ensures that users can upgrade or switch models without manual intervention, while local inference ensures low latency and data security. Additionally, the system ensures compliance with data protection laws and enforces strict access controls for both developers and users.

Through its modular, scalable, and privacy-aware architecture, the invention provides a flexible and intelligent infrastructure for integrating AI capabilities into edge-based smart home devices, empowering both developers and users in the evolving AI ecosystem.

### BRIEF DESCRIPTION OF THE DRAWINGS

The accompanying drawings, which are included to provide a further understanding of the inventive concepts and are incorporated in and constitute a part of this specification, illustrate exemplary embodiments of the inventive concepts, and, together with the description, explain the principles of the inventive concepts.

FIG. 1: Depicts the developer workflow for model development, including registration, model upload, validation, testing, and publishing.

FIG. 2: Illustrates the user journey, from browsing the marketplace to purchasing, deploying, and receiving notifications from AI models.

FIG. 3: Shows the interaction between users, developers, and the AI marketplace platform.

FIG. 4: Provides an overview of the AI marketplace system architecture, including the server, edge devices, and applications.

### DETAILED DESCRIPTION OF EMBODIMENTS

In the following description, for the purposes of explanation, numerous specific details are set forth to provide a thorough understanding of various exemplary embodiments. It is apparent, however, that various exemplary embodiments may be practiced without these specific details or with one or more equivalent arrangements.

In the accompanying figures, the size and relative sizes of elements may be exaggerated for clarity and descriptive purposes.

The terminology used herein is for the purpose of describing embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

The present invention relates to a system and method for distributing and deploying artificial intelligence (AI) models to edge devices, particularly security and smart home devices such as smart doorbells, AI-enabled IoT hubs, and functionally similar appliances. This invention addresses the technical challenges of securely packaging, distributing, deploying, and executing AI models in real-time on resource-constrained, network-connected hardware while enabling an ecosystem where developers can publish and monetize their models and users can personalize their devices through model selection and configuration.

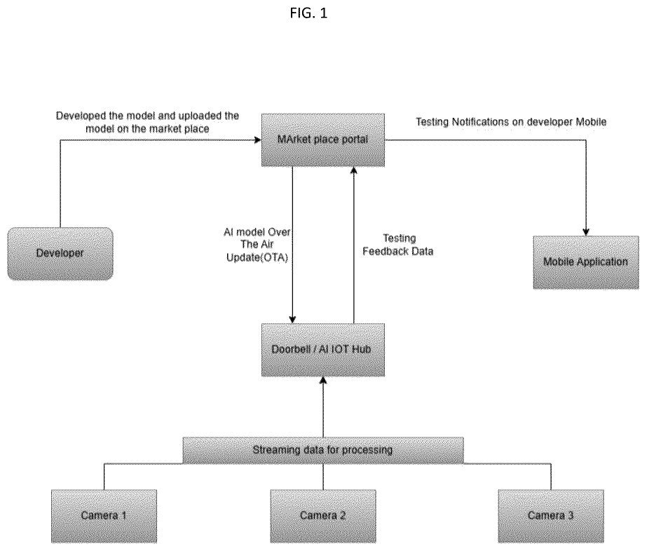

FIG. 1 illustrates the initial development and deployment phase of an AI model within the AI Marketplace ecosystem. The process begins with a developer creating and uploading an AI model to the marketplace in test mode. The test model will be deployed over-the-air (OTA) to the doorbell or another edge device. During testing, the developer will receive notifications to verify whether the system is functioning as intended. The uploaded model undergoes testing, during which feedback data is collected and relayed back to the developer. Once validated, the model is distributed via Over-The-Air (OTA) updates to subscribed devices, such as a Doorbell. The doorbell processes streaming data from multiple cameras (Camera 1, Camera 2, Camera 3), enabling real-time AI-driven functionality. Developers can test models on the doorbell or a compatible AI IoT hub using the provided SDK. However, end users can only run models directly on the doorbell hardware, or smart devices like cameras etc. which include built-in AI IoT hub functionality.

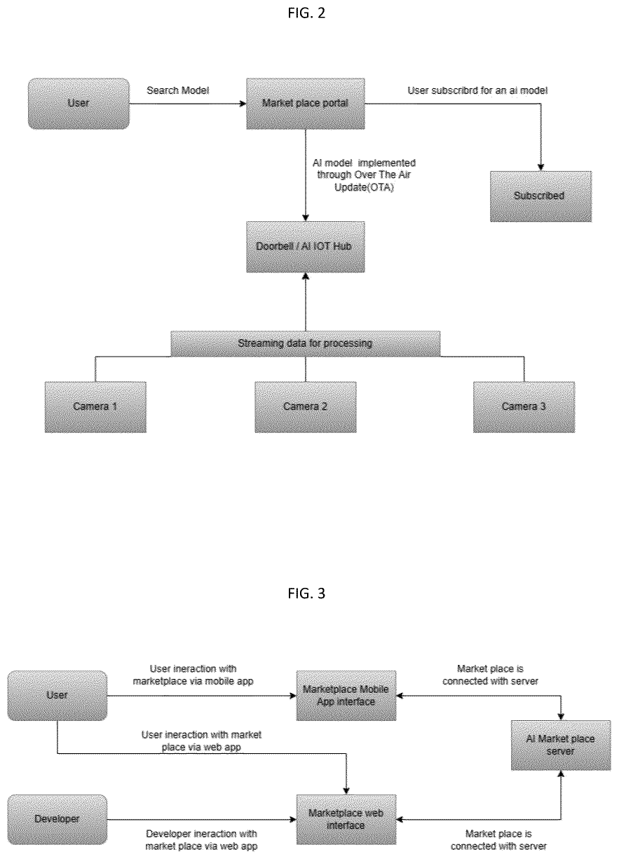

FIG. 2 depicts the user interaction with the AI Marketplace for model subscription and implementation. A user searches for an AI model through the marketplace portal and subscribes to a selected model. The subscribed model is then delivered and implemented on the user's device (i.e. Doorbell) via OTA updates. The hub processes streaming data from connected cameras (Camera 1, Camera 2, Camera 3), leveraging the newly deployed AI model for enhanced functionality.

FIG. 3 showcases the multi-platform accessibility of the AI Marketplace. Users can interact with the marketplace through either a mobile app or a web app interface, both of which are connected to the central marketplace server. Similarly, developers engage with the marketplace via a web app to upload and manage their AI models. The figure emphasizes the seamless connectivity between user/developer interfaces and the marketplace server, facilitating efficient model distribution and updates.

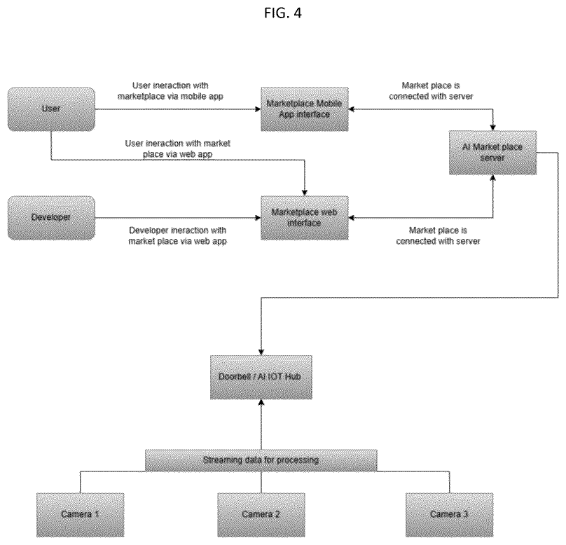

FIG. 4 provides an integrated view of the AI Marketplace ecosystem. It highlights the interactions between users and developers with the marketplace via mobile and web interfaces, all connected to the AI Marketplace server. The server orchestrates the deployment of AI models to end-user devices, such as the Doorbell/AI IoT Hub, which processes data streams from multiple cameras (Camera 1, Camera 2, Camera 3). This figure consolidates the workflows of model development, subscription, and OTA updates, illustrating the end-to-end functionality of the system.

These figures collectively demonstrate the innovative processes and interactions within the AI Marketplace, covering model development, user subscription, multi-platform accessibility, and seamless OTA updates to IoT devices.

### System Architecture

The system comprises three core components: (1) a Marketplace Server, (2) User Devices, and (3) Hardware Devices such as smart doorbells or IoT hubs. The marketplace server is configured to receive AI models from registered developers, validate these models for compatibility and security, store them in an encrypted repository, and offer them via a browsable catalog to users. The user devices, typically smartphones, tablets, or web clients, interface with the marketplace to browse available AI models, initiate purchases, configure settings, and receive intelligent alerts. The hardware devices host the inference engine and streaming engine, download selected models from the marketplace server via an over-the-air (OTA) mechanism, and execute inference locally on camera input for real-time detection tasks.

The invention supports a broad spectrum of hardware including, but not limited to, smart doorbells, video intercoms, AI security cameras, baby monitors with AI functions, smart locks with integrated video modules, smart garage openers, and home security hubs with edge AI capabilities. All such devices operate using the same system framework described herein.

### Developer Flow

In one embodiment, the developer journey within the AI Marketplace begins with registration and login through the web dashboard, where developers provide credentials, personal details, areas of expertise, and portfolio links. After registration, the developer sets up a Profile Page, including a biography, project listings, and optionally a company logo, along with any required verification documents depending on marketplace policies. To create a new model listing, the developer selects “Add New Model” and fills out key information such as the model's name, description, category (e.g., People Detection, Package Detection), compatible device types (e.g., Doorbell Hardware v1, Cloud), pricing model (free, one-time purchase, or subscription), and an optional trial offering. Model files are uploaded in supported formats like ONNX or TensorFlow Lite.

Following the upload, the AI Marketplace automatically initiates a validation and compatibility check, ensuring file format integrity, runtime compatibility (including size and performance benchmarks), and conducting a security scan for malicious code. If the model passes these checks, it moves forward; otherwise, feedback is provided for corrections. Developers then perform internal testing by deploying their models to reference devices such as doorbell hardware or AI IoT hub devices, receiving sample detection outputs via a mobile app or marketplace logs. Once testing is successful, developers publish the model, making it available to end users on the marketplace.

Post-publication, developers monitor downloads, user reviews, and reported issues, responding to user queries through community forums if needed. They also have the ability to upload updated versions of their models, such as improvements for enhanced accuracy. For paid models, developers can track earnings and receive payouts according to the marketplace's scheduled payment cycles.

### User Flow

In one embodiment, the user flow begins with the end user registering or logging into the system. The user downloads and installs the mobile application on an Android or iOS device or alternatively accesses the web application via a browser interface. Once registered, the user navigates to the AI Marketplace section, where various AI models are organized into categories such as People Detection, Package Detection, Pet Monitoring, Fire/Smoke Detection, and Anomaly Detection (e.g., motion during nighttime). Users may browse these categories or utilize a search bar to locate models based on specific keywords.

Upon selecting a model of interest, the user is presented with a detailed model view, which includes a description, demo videos or screenshots, user ratings and reviews, pricing information (indicating whether the model is free or paid), and an option to activate a trial period if available. To install a selected model, the user initiates a purchase or free trial through the marketplace interface. Once confirmed, the system automatically configures and deploys the AI model onto the user's Doorbell or AI IoT Hub device via an Over-The-Air (OTA) update mechanism.

Following deployment, the device's Streaming Engine downloads the selected AI model, and the Local Inference Engine activates it for real-time processing. As events occur, such as the presence of an unidentified individual or the delivery of a package, the model processes the incoming video streams and generates event-based notifications. These notifications, containing information such as a snapshot or video clip, the type of event, a timestamp, and the camera source, are pushed to the user's mobile application in real time.

The user may then review these notifications through a historical event timeline, access recorded clips, and either dismiss false alerts or confirm detections. Users are further enabled to provide feedback by rating the model and submitting a review within the marketplace platform. Additionally, users can manage their active model subscriptions through the application, including the ability to uninstall, pause, or resume models, and to configure settings for automatic model updates if desired.

### Model Execution and Security

The system prioritizes privacy and performance by ensuring all inference occurs on the local device, minimizing reliance on cloud computing and avoiding unnecessary transmission of raw video data. Communication between components, including model transfers and alert notifications, are encrypted using industry-standard protocols such as TLS. Developers and users undergo strict access control procedures, and the system may be configured to enforce regulatory compliance, such as GDPR, by anonymizing user data and managing consent for any outbound data streams.

### Broader Applicability

While primarily illustrated in the context of smart home security, the system is applicable to a wide range of edge AI environments where real-time video analytics, model customization, and secure OTA deployment are critical. For instance, smart retail analytics systems, industrial safety cameras, agricultural monitoring systems, and AI-enhanced telehealth devices can benefit from the same underlying framework.

### Extensibility and Modularity

The architecture supports modular upgrades allowing for pluggable inference engines, third-party payment integrations, and support for emerging AI model formats. Furthermore, the system is extensible to non-visual modalities such as audio or sensor-based detection (e.g., glass break sensors or air quality monitoring), expanding the range of supported AI applications beyond visual input.

An embodiment of the present invention discloses a system for distributing and deploying artificial intelligence (AI) models for a hardware device, the system comprising:
a) a marketplace server configured to:
   receive AI models from developers in specified formats;
   store the AI models and associated metadata in a database;
   provide an interface for users to browse, purchase, or download said AI models; and manage licensing and pricing for said AI models;
b) a user device in communication with the marketplace server, the user device being configured to:
   display a catalog of available AI models;
   allow the users to select at least one of the AI models and initiate a purchase or download transaction; and
   configure settings for said selected AI model; and
c) a hardware device in communication with the marketplace server, the hardware device comprising:
   an inference engine configured to load and execute the selected AI model;
   a camera module capturing video input;
   a device controller configured to receive the selected AI model from the marketplace server and deploy the selected AI model to the inference engine; and
   a notification subsystem configured to transmit alerts in response to detection events recognized by the selected AI model.

The marketplace server comprises:
a) a Model Storage Module configured to maintain a secure repository of the AI models uploaded by the developers, said AI models are encrypted at rest and are stored with metadata tags;
b) a Developer Management Module configured to store developer profiles comprising credentials, portfolio of the uploaded models, user ratings, and payment details;
c) a User Management Module configured to manage user accounts, subscription tiers, purchase history, device enrollment data, and usage statistics;
d) a Payment and License Control Module configured to facilitate transactions, subscription renewals, license issuance, and usage-based billing for the AI models, optionally integrated with third-party payment gateways; and
e) a Compatibility and Validation Engine configured to ensure that the AI models meet certain hardware compatibility requirements, security validations, and format specifications. The compatibility and validation engine is configured to automate tasks like converting the uploaded model to an optimized runtime format for the custom hardware or verifying correct input/output tensor shapes for real-time video streaming from the hardware device.

The hardware device is integrated with a camera and, optionally, on-device compute resources, the hardware device comprises:
a) a Streaming Engine which is a software subsystem responsible for integrating, managing, and processing live video streams originating from the hardware device's camera, additional external cameras like IP cameras or AI IoT hub-connected cameras, or any authorized network-connected visual source;
b) a Local Inference Engine which is a software component capable of loading and executing AI models;
c) a Firmware or an Operating System that manages device functions, network connections, event triggers, and security protocols;
d) a Device Controller which is a module that connects to the AI marketplace server, receives model updates or new model downloads, and sets up the model for local inference; and
e) a Notification Subsystem to send notifications to the user devices when an event of interest is detected by the loaded model.

The steaming engine:
a) standardizes incoming video feeds, converts streams into compatible formats if needed, and manages the real-time ingestion of frames;
b) acts as the primary video frame distributor, feeding synchronized frames into the Local Inference Engine for AI processing;
c) optimizes network usage by handling bandwidth management, frame rate adjustments, stream buffering, error correction, and reconnection protocols for unstable networks;
d) supports industry-standard protocols, or proprietary streaming methods; and
e) monitors stream health metrics and interfaces with a Firmware or an operating system for the system resource management. The hardware device automatically downloads model updates from the marketplace server upon the release of an updated model version, and the device controller swaps the loaded model with the updated model version in real time.

The user device comprises a Marketplace UI that allows the users to browse the AI models, read developer profiles, check ratings, and view demo videos; a Model Configuration UI that presents model parameters or options to be configured by the user; and Subscription and Billing UI that provides subscription management, purchase details, receipts, and usage analytics. The user device further comprises a mobile application that displays real-time or near real-time notifications of events detected by the selected AI model and provides event review functionality enabling the user to label, store, or delete recorded events.

The embodiment further comprises a developer dashboard configured for the developer to:
a) have a Model Upload Interface which is a web-based portal for uploading the AI models in supported formats, the interface provides guidance on how to package or containerize the model, supply metadata, define licensing terms, and set pricing;
b) Test and Validate the models on reference hardware or in a simulated environment provided by the marketplace, automatically checking for runtime compatibility, memory usage, inference speed, and model accuracy;
c) view performance statistics, manage updates and push version upgrades; and
d) receive user feedback or questions, collaborate on feature requests, and address issues.

The AI marketplace of the invention facilitates a developer workflow comprising registration and login via a web dashboard, creation of a developer profile including credentials and verification documents, listing of new AI models with metadata such as name, description, category, compatible device types, pricing, and trial options, uploading of model files in supported formats, automated validation for format, runtime compatibility, and security, internal testing on reference devices with sample detections, publishing of validated models for end-user access, post-publishing monitoring of downloads and user feedback, capability to update and re-upload improved model versions, and tracking of earnings with scheduled payouts for paid models.

The AI marketplace of the invention further facilitates a user workflow comprising registering or logging into a mobile or web application, browsing the AI model marketplace by category or keyword, viewing detailed information about each model including descriptions, media, pricing, and trial options, selecting and installing a model via over-the-air deployment to a compatible edge device such as a doorbell or AI IoT hub, where the model is activated by a local inference engine to process real-time camera feeds and generate intelligent notifications sent to the user's mobile device, reviewing event history and media clips, providing feedback through ratings and reviews, and managing model subscriptions, including options to uninstall, pause, or enable automatic updates.

The system ensures security and privacy by transmitting model data and inference results over encrypted channels, performing on-device inference to minimize data exposure and retain raw video streams locally unless authorized, enforcing strict access control through developer credential management and strong user authentication, and implementing privacy practices in compliance with applicable data protection regulations including GDPR.

The hardware device comprises a smart doorbell or a functionally similar Internet-of-Things (IoT) or artificial intelligence (AI) hub device selected from the group consisting of: a smart security camera, a smart video intercom system, a smart floodlight camera, a smart lock with an integrated camera module, a home security hub with edge AI processing capabilities, a smart door viewer or peephole camera, a baby monitor with AI features, a smart garage opener with camera integration, a smart mailbox or parcel locker with detection sensors, and a smart light switch or thermostat equipped with camera and motion detection functionality.

Another embodiment of the invention comprises a method for distributing and deploying artificial intelligence (AI) models for execution on a hardware device, the method comprising:
(a) receiving, at a marketplace server, an AI model submitted by a developer in a supported format along with associated metadata;
(b) validating the AI model for format compliance, runtime compatibility with designated hardware, and absence of malicious code;
(c) storing the validated AI model in a secure model repository;
(d) enabling an end user, through a user interface on a mobile or web application, to browse, select, and purchase or download the AI model;
(e) transmitting the selected AI model to a target hardware device over a network via an over-the-air (OTA) deployment mechanism;
(f) loading and executing the AI model on the hardware device using a local inference engine to process real-time video input captured by a camera module;
(g) generating event notifications based on detections made by the AI model; and
(h) transmitting the event notifications to the user device.

The method further comprises:
(a) enabling the developer to register via a web-based dashboard;
(b) creating a developer profile including credentials, portfolio, and verification documents;
(c) listing a new AI model including metadata such as name, category, compatible device types, pricing model, and trial availability; and
(d) testing the model on reference hardware and receiving detection samples before publishing the model to the marketplace.

The method further comprises:
(a) enabling the end user to register via the mobile or web application;
(b) browsing AI models by category or keyword;
(c) viewing detailed information about the AI models including description, demo media, ratings, pricing, and trial availability; and
(d) initiating the installation of a selected model on the user's enrolled hardware device.

The method further comprises:
(a) allowing the end user to view a timeline of recorded detection events;
(b) providing access to video clips or snapshots associated with each detection;
(c) enabling the user to confirm or dismiss individual detections; and
(d) accepting user-generated feedback including ratings and reviews for the deployed AI model.

The method further comprises wherein the marketplace server implements security and privacy controls comprising:
(a) encrypting transmissions of AI models and detection results using secure communication protocols;
(b) performing inference on-device to minimize exposure of raw video data;
(c) retaining video content locally on the hardware device unless user authorization is granted for remote transmission; and
(d) enforcing access control through developer credential management and strong user authentication compliant with data protection regulations.

### EXAMPLES OF USE

Smart Home Monitoring: A homeowner wants advanced motion detection that filters out known family members, detects packages, and identifies potential intruders. They purchase relevant AI models from the marketplace and deploy them on their doorbell hardware.

Business Surveillance: A store owner needs a specialized model to detect shoplifting patterns or count foot traffic. They acquire a suitable model from the marketplace, integrate it onto cameras in the store, and set up real-time notifications.

Public Safety: Municipalities may adopt specialized models for crowd management or hazard detection in public areas. Developers can supply these specialized detection models, providing local governments with easy access to advanced AI capabilities.

### ADVANTAGES OF THE INVENTION

Modular AI Deployment to Edge Devices: The invention enables AI models to be deployed dynamically to edge hardware (e.g., smart doorbells, cameras, IoT hubs) without requiring firmware reflashing or manual installation, making AI feature updates seamless and user-configurable.

Marketplace-Driven Ecosystem: By providing a centralized AI model marketplace, the invention allows developers to publish, monetize, and manage their models, while giving users access to a wide catalog of task-specific models tailored to their hardware capabilities and needs.

Over-the-Air (OTA) Delivery of AI Models: The OTA update mechanism enables real-time delivery, replacement, and upgrading of models directly to devices, significantly reducing maintenance costs and downtime.

Local Inference for Enhanced Privacy and Low Latency: AI inference occurs locally on the hardware device, eliminating the need to send video streams to the cloud. This ensures data privacy, minimizes bandwidth usage, and provides faster response times for event detection.

Personalized AI Capabilities: Users can tailor their smart devices by selecting models relevant to their lifestyle or environment (e.g., pet detection, fire alerting, package delivery), enhancing user experience and functionality beyond factory defaults.

Automatic Compatibility and Security Checks: The system performs automatic validation of uploaded models for hardware compatibility, format correctness, and security, reducing the likelihood of deployment errors and malicious activity.

Developer Tools and Analytics: Developers benefit from a powerful backend dashboard for managing their model lifecycle, receiving user feedback, tracking earnings, and analyzing usage metrics, supporting a sustainable monetization model.

Real-Time User Notifications with Contextual Media: Intelligent event notifications delivered to users include context (e.g., snapshots, timestamps, event type), enabling informed and immediate action from the end user.

Regulatory Compliance and Security by Design: The system ensures secure transmission of model data using encrypted protocols, on-device inference to reduce data leakage, strong user and developer authentication, and optional GDPR-aligned privacy controls.

Trial and Subscription Flexibility: Support for different pricing models (free trials, subscriptions, one-time purchases) improves user adoption and allows developers to experiment with monetization strategies.

Scalable and Future-Proof Architecture: The modular and extensible design allows future integration of new AI domains (e.g., audio-based detection, multimodal inference) and supports third-party integrations (e.g., cloud backup, smart home platforms).

Improved Security Monitoring and Smart Automation: Enables users to convert basic security cameras or doorbells into intelligent sensing devices capable of detecting nuanced patterns such as loitering, fire, motion anomalies, or recognized individuals.

What is claimed is:

1. A system for distributing and deploying artificial intelligence (AI) models for a hardware device, the system comprising:
a marketplace server configured to:
receive AI models from developers in specified formats;
store the AI models and associated metadata in a database;
provide an interface for users to browse, purchase, or download said AI models; and
manage licensing and pricing for said AI models;
a user device in communication with the marketplace server, the user device being configured to:
display a catalog of available AI models;
allow the users to select at least one of the AI models and initiate a purchase or download transaction; and
configure settings for said selected AI model; and
a hardware device in communication with the marketplace server, the hardware device comprising:
an inference engine configured to load and execute the selected AI model;
a camera module capturing video input;
a device controller configured to receive the selected AI model from the marketplace server and deploy the selected AI model to the inference engine; and
a notification subsystem configured to transmit alerts in response to detection events recognized by the selected AI model.

2. The system of claim 1, wherein the marketplace server comprises:
a Model Storage Module configured to maintain a secure repository of the AI models uploaded by the developers, said AI models are encrypted at rest and are stored with metadata tags;
a Developer Management Module configured to store developer profiles comprising credentials, portfolio of the uploaded models, user ratings, and payment details;
a User Management Module configured to manage user accounts, subscription tiers, purchase history, device enrollment data, and usage statistics;
a Payment and License Control Module configured to facilitate transactions, subscription renewals, license issuance, and usage-based billing for the AI models; and
a Compatibility and Validation Engine configured to ensure that the AI models meet certain hardware compatibility requirements, security validations, and format specifications.

3. The system of claim 2, wherein the compatibility and validation engine is configured to automate tasks like converting the uploaded model to an optimized runtime format for the custom hardware or verifying correct input/output tensor shapes for real-time video streaming from the hardware device.

4. The system of claim 2, wherein the payment and license control module is integrated with third-party payment gateways.

5. The system of claim 1, wherein the hardware device is integrated with a camera and on-device compute resources, the hardware device comprises:
a Streaming Engine which is a software subsystem responsible for integrating, managing, and processing live video streams originating from the hardware device's camera, additional external cameras like IP cameras or AI IoT hub-connected cameras, or an authorized network-connected visual source;
a Local Inference Engine which is a software component capable of loading and executing AI models;
a Firmware or an Operating System that manages device functions, network connections, event triggers, and security protocols;
a Device Controller which is a module that connects to the AI marketplace server, receives model updates or new model downloads, and sets up the model for local inference; and
a Notification Subsystem to send notifications to the user devices when an event of interest is detected by the loaded model.

6. The system of claim 5, wherein the streaming engine:
standardizes incoming video feeds, converts streams into compatible formats if needed, and manages the real-time ingestion of frames;
acts as the primary video frame distributor, feeding synchronized frames into the Local Inference Engine for AI processing;
optimizes network usage by handling bandwidth management, frame rate adjustments, stream buffering, error correction, and reconnection protocols for unstable networks;
supports industry-standard protocols, or proprietary streaming methods; and
monitors stream health metrics and interfaces with a Firmware or an operating system for the system resource management.

7. The system of claim 1, wherein the hardware device automatically downloads model updates from the marketplace server upon the release of an updated model version, and the device controller swaps the loaded model with the updated model version in real time.

8. The system of claim 1, wherein the user device comprises:
a Marketplace UI that allows the users to browse the AI models, read developer profiles, check ratings, and view demo videos;
a Model Configuration UI that presents model parameters or options to be configured by the user; and
Subscription and Billing UI that provides subscription management, purchase details, receipts, and usage analytics.

9. The system of claim 1, wherein the user device further comprises a mobile application that displays real-time or near real-time notifications of events detected by the selected AI model and provides event review functionality enabling the user to label, store, or delete recorded events.

10. The system of claim 1, further comprising a developer dashboard configured for the developer to:
have a Model Upload Interface which is a web-based portal for uploading the AI models in supported formats, the interface provides guidance on how to package or containerize the model, supply metadata, define licensing terms, and set pricing;
Test and Validate the models on reference hardware or in a simulated environment provided by the marketplace, automatically checking for runtime compatibility, memory usage, inference speed, and model accuracy;
view performance statistics, manage updates and push version upgrades; and
receive user feedback or questions, collaborate on feature requests, and address issues.

11. The system of claim 1, wherein the AI marketplace facilitates a developer workflow comprising registration and login via a web dashboard, creation of a developer profile including credentials and verification documents, listing of new AI models with metadata such as name, description, category, compatible device types, pricing, and trial options, uploading of model files in supported formats, automated validation for format, runtime compatibility, and security, internal testing on reference devices with sample detections, publishing of validated models for end-user access, post-publishing monitoring of downloads and user feedback, capability to update and re-upload improved model versions, and tracking of earnings with scheduled payouts for paid models.

12. The system of claim 1, wherein the AI marketplace facilitates a user workflow comprising registering or logging into a mobile or web application, browsing the AI model marketplace by category or keyword, viewing detailed information about each model including descriptions, media, pricing, and trial options, selecting and installing a model via over-the-air deployment to a compatible edge device such as a doorbell or AI IoT hub, where the model is activated by a local inference engine to process real-time camera feeds and generate intelligent notifications sent to the user's mobile device, reviewing event history and media clips, providing feedback through ratings and reviews, and managing model subscriptions, including options to uninstall, pause, or enable automatic updates.

13. The system of claim 1, wherein the system ensures security and privacy by transmitting model data and inference results over encrypted channels, performing on-device inference to minimize data exposure and retain raw video streams locally unless authorized, enforcing strict access control through developer credential management and strong user authentication, and implementing privacy practices in compliance with applicable data protection regulations including GDPR.

14. The system of claim 1, wherein the hardware device comprises a smart doorbell or a functionally similar Internet-of-Things (IoT) or artificial intelligence (AI) hub device selected from the group consisting of: a smart security camera, a smart video intercom system, a smart floodlight camera, a smart lock with an integrated camera module, a home security hub with edge AI processing capabilities, a smart door viewer or peephole camera, a baby monitor with AI features, a smart garage opener with camera integration, a smart mailbox or parcel locker with detection sensors, and a smart light switch or thermostat equipped with camera and motion detection functionality.

15. A method for distributing and deploying artificial intelligence (AI) models for execution on a hardware device, the method comprising:
(a) receiving, at a marketplace server, an AI model submitted by a developer in a supported format along with associated metadata;
(b) validating the AI model for format compliance, runtime compatibility with designated hardware, and absence of malicious code;
(c) storing the validated AI model in a secure model repository;
(d) enabling an end user, through a user interface on a mobile or web application, to browse, select, and purchase or download the AI model;
(e) transmitting the selected AI model to a target hardware device over a network via an over-the-air (OTA) deployment mechanism;
(f) loading and executing the AI model on the hardware device using a local inference engine to process real-time video input captured by a camera module;
(g) generating event notifications based on detections made by the AI model; and
(h) transmitting the event notifications to the user device.

16. The method of claim 15, further comprising:
(a) enabling the developer to register via a web-based dashboard;
(b) creating a developer profile including credentials, portfolio, and verification documents;
(c) listing a new AI model including metadata such as name, category, compatible device types, pricing model, and trial availability; and
(d) testing the model on reference hardware and receiving detection samples before publishing the model to the marketplace.

17. The method of claim 15, further comprising:
(a) enabling the end user to register via the mobile or web application;
(b) browsing AI models by category or keyword;
(c) viewing detailed information about the AI models including description, demo media, ratings, pricing, and trial availability; and
(d) initiating the installation of a selected model on the user's enrolled hardware device.

18. The method of claim 15, wherein the hardware device comprises:
(a) a streaming engine configured to ingest and standardize video streams from a camera module;
(b) a local inference engine configured to load the deployed model and process video frames in real-time;
(c) a device controller configured to receive, install, and activate the model; and
(d) a notification subsystem configured to generate and send alerts to the user device upon detection of defined events.

19. The method of claim 15, further comprising:
(a) allowing the end user to view a timeline of recorded detection events;
(b) providing access to video clips or snapshots associated with each detection;
(c) enabling the user to confirm or dismiss individual detections; and
(d) accepting user-generated feedback including ratings and reviews for the deployed AI model.

20. The method of claim 15, wherein the marketplace server implements security and privacy controls comprising:
(a) encrypting transmissions of AI models and detection results using secure communication protocols;
(b) performing inference on-device to minimize exposure of raw video data;
(c) retaining video content locally on the hardware device unless user authorization is granted for remote transmission; and
(d) enforcing access control through developer credential management and strong user authentication compliant with data protection regulations.
